(19) United States
(12) Patent Application Publication
(10) Pub. No.: US 2017/0287522 A1
(43) Pub. Date: Oct. 5, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Eiji Imao, Yokohama-shi (JP)

(21) Appl. No.: 15/459,733

(22) Filed: Mar. 15, 2017

(30) Foreign Application Priority Data
Mar. 31, 2016 (JP) 2016-072596

(51) Int. Cl. G11B 27/10; H04L 29/08; H04N 5/77; G06F 17/30; H04N 1/00; H04N 21/6437; H04N 21/8547; H04L 29/06; H04N 1/32

(52) U.S. Cl. CPC G11B 27/10; H04L 65/608; H04L 67/12; H04N 5/77; H04N 1/32128; H04N 1/00244; H04N 21/6437; H04N 21/8547; G06F 17/30259; G06F 17/30268; H04N 2201/0084; H04N 2201/3215

(57) ABSTRACT

An information processing apparatus includes an acquisition unit configured to acquire a first type of data, a generation unit configured to generate a type of time information according to time information of a second type of data among a plurality of types of time information as time information of the first type of data, and a transmission unit configured to transmit the first type of data and the time information of the first type of data that is generated by the generation unit to an external apparatus, which is configured to receive the first type of data and the second type of data from plurality of apparatuses and then perform processing while associating the first type of data and second type of data with each other.

### BACKGROUND OF THE INVENTION

### Field of the Invention

The aspect of the embodiments relates to a technique for generating time information of acquired data.

### Description of the Related Art

Conventionally, there have been systems in which a network camera transmits a captured image to a server apparatus and the server apparatus performs processing such as recording, displaying, and analyzing the captured image. Further, there have also been systems in which a sensor transmits a detection result, such as a measured value, to the server apparatus, and the server apparatus performs the processing while associating the detection result detected by the sensor and the captured image acquired by the network camera with each other.

Japanese Patent Application Laid-Open No. 2013-251800 discusses that the server apparatus extracts a feature point on a time axis with respect to each of a result of analyzing the captured image and the detection result of the sensor, and performs matching of these feature points, thereby associating the captured image and the detection result with each other. Further, Japanese Patent Application Laid-Open No. 2013-251800 also discusses that a plurality of cameras transmits captured images, a plurality of sensors transmits detection results, and the server apparatus associates these captured images and detection results with each other.

However, this configuration may lead to an increase in a processing load regarding the association based on the time information on the server apparatus, which performs the processing while associating the plurality of types of data received from the plurality of apparatuses with each other. For example, suppose that the server apparatus performs the processing while associating the detection results detected by the sensors and the acquired captured images that are received from the plurality of apparatuses with each other. In this case, if a type of the time information added to the captured images and a type of the time information added to the detection results of the sensors are different from each other, a likely consequence is that the server apparatus engages in processing for determining a correspondence relationship between these pieces of time information for the association. Especially, in a case where the serve apparatus receives the captured images and the detection results from a large number of apparatuses and performs the processing regarding the association between a large number of captured images and detection results, it is considered that the processing load on the server apparatus increases.

### SUMMARY OF THE INVENTION

According to an aspect of the embodiments, an information processing apparatus includes an acquisition unit configured to acquire a first type of data, a generation unit configured to generate a type of time information according to time information of a second type of data among a plurality of types of time information as time information of the first type of data, and a transmission unit configured to transmit the first type of data and the time information of the first type of data that is generated by the generation unit to an external apparatus, which is configured to receive the first type of data and the second type of data from plurality of apparatuses and then perform processing while associating the first type of data and second type of data with each other.

Further features of the disclosure will become apparent from the following description of exemplary embodiments with reference to the attached drawings.

### BRIEF DESCRIPTION OF THE DRAWINGS

FIG. 1 illustrates a configuration of an information processing system according to an exemplary embodiment of the disclosure.

FIG. 2 illustrates communication patterns in the information processing system.

FIG. 3 is a block diagram illustrating a hardware configuration of an information processing apparatus according to an exemplary embodiment.

FIG. 4 illustrates an example of a management table used by the information processing apparatus in processing for transferring sensor data.

FIG. 5 is a flowchart illustrating an operation of the information processing apparatus regarding the transfer processing.

### DESCRIPTION OF THE EMBODIMENTS

In the following description, an exemplary embodiment of the disclosure will be described with reference to the drawings. However, not all of combinations of features that will be described in the following exemplary embodiment are necessarily essential to the disclosure.

### <System Configuration>

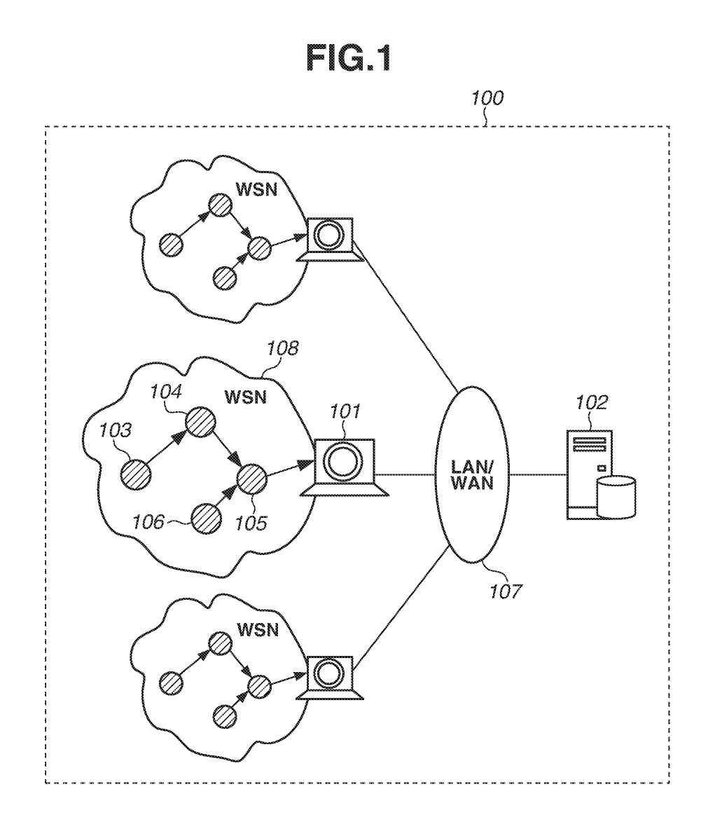

FIG. 1 illustrates a configuration of an information processing system 100 according to the present exemplary embodiment. The information processing system 100 includes a wireless sensor network (WSN) including sensors 103, 104, 105, and 106, an information processing apparatus 101, a local area network (LAN)/wide area network (WAN) 107, and a server apparatus 102. In the present exemplary embodiment, the sensors 103, 104, 105, and 106 will be referred to as the sensors 103 to 106 when being collectedly referred to. Further, the sensors 103 to 106 will be referred to as the sensor 103 or simply the sensor when an intended sensor is at least one of the sensors 103 to 106.

The information processing apparatus 101 is connected to the LAN/WAN 107, which is a network including a LAN and a WAN. The connection between the information processing apparatus 101 and the LAN/WAN 107 may be a wired connection, such as Ethernet (registered trademark), or may be a wireless connection, such as a wireless LAN and a mobile communication line. In the present exemplary embodiment, the information processing system 100 will be described assuming that the information processing apparatus 101 is connected to the server apparatus 102 via the LAN/WAN 107, but the information processing apparatus 101 may be connected to the server apparatus 102 via either one of a WAN and a LAN. Further, in the present exemplary embodiment, the information processing system 100 will be described assuming that a plurality of information processing apparatuses 101 is connected to a single server apparatus 102 via the LAN/WAN 107, and focusing on one of this plurality of information processing apparatuses 101.

In the present exemplary embodiment, the information processing apparatus 101 is a network camera, and transmits a captured moving image to the server apparatus 102 via the LAN/WAN 107 by streaming. Assume that Real-time Transport Protocol (RTP) is used as a protocol for the streaming. RTP is a protocol used in real-time image distribution, such as live image distribution. The protocol used in the transmission of the captured image from the information processing apparatus 101 to the server apparatus 102 is not limited to RTP. Further, the transmission of the captured image is not limited to the streaming, and may be, for example, distribution through a download. Further, the captured image transmitted by the information processing apparatus 101 may be a still image instead of the moving image. Further, the information processing apparatus 101 may be, for example, a personal computer (PC), a smart-phone, a router, or a server apparatus, and/or may transmit a captured image received from outside without including an imaging unit therein.

The server apparatus 102 receives the captured image transmitted from the information processing apparatus 101 by the streaming, and performs processing such as an analysis, a storage, and a display of the image. The server apparatus 102 may be, for example, a PC or a smart-phone, or may be a server function constructed on a virtualized platform generally called a cloud.

Further, the information processing apparatus 101 is also connected to the WSN 108. Each of the sensors 103 to 106 included in the WSN 108 is an apparatus capable of measuring some value or detecting an event, such as a gyroscope value, an acceleration, an orientation, a distance, a vibration, a temperature, an illuminance, ultraviolet (UV), an atmospheric pressure, gas, radioactivity, odor, opening and closing of a door or a window, and invasion detection. These sensors 103 to 106 each transmit a detection result including at least any of information indicating that a predetermined event is detected and a numerical value acquired from the measurement, to the information processing apparatus 101. Besides that, for example, each of the sensors 103 to 106 may periodically transmit information indicating whether a current condition satisfies a predetermined environmental condition, such as a condition that a temperature at an installed position is a threshold value or higher. In actual transmission processing, each of the sensors 103 to 106 transmits the information while putting sensor data including a destination address and the like in addition to the detection result into a packet.

The detection results may include a detection result to be processed in association with the captured image and a detection result not to be processed in this manner by the server apparatus 102. The processing that the server apparatus 102 performs while associating the captured image and the detection result with each other is, for example, processing for performing control so as to display a captured image having time information matching or close to time information of the detection result received by the server apparatus 102. The time information regarding the detection result is information indicating, for example, a timing when the measurement is carried out by the sensor, a timing when the predetermined event is detected, or a timing when the detection result is transmitted. The server apparatus 102 performs such association processing, by which, when the sensor detects occurrence of some event, a user can check a captured image formed by imaging a situation when this event has occurred. One specific example is that, when receiving the detection result indicating that the opening or the closing of the door is detected by the sensor, the server apparatus 102 performs processing for displaying a captured image formed by imaging a vicinity of the door around the timing of this detection on a display unit. Further, the processing that the server apparatus 102 performs while associating the captured image and the detection result with each other is not limited thereto, and may be, for example, processing for recording a captured image selected according to the time information regarding the detection result, and processing for analyzing the image based on the detection result and the captured image.

For example, the server apparatus 102 may specify which detection result is supposed to be associated with the captured image among the detection results from the sensors 103 to 106 to the information processing apparatus 101. Alternatively, the user may specify this detection result, or an application in the information processing apparatus 101 may automatically specify this detection result. The information processing apparatus 101 determines whether the received detection result is supposed to be associated with the captured image according to these specified settings. For example, a specific type of detection result, such as the vibration and the invasion detection, may be specified to be associated with the captured image, and other types of detection results may be specified not to be associated with the captured image. Alternatively, for example, a detection result detected by a sensor set up at an object or in an imaging target area imaged by the information processing apparatus 101 may be specified to be associated with the captured image, and a detection result detected by a sensor set up at a location other than that may be specified not to be associated with the captured image.

The information processing apparatus 101 and the sensors 103 to 106 construct the WSN 108, which is a mesh network, via wireless personal area network (PAN) communication. However, the WSN 108 is not limited to the mesh-type network topology, and may be a network like a star-type network. Further, in a case where the star-type network centered at the information processing apparatus 101 is constructed, a communication standard used in the communication with the information processing apparatus 101 may be different for each sensor. One sensor may communicate with the information processing apparatus 101 based on ZigBee (registered trademark) while another sensor may communicate with the information processing apparatus 101 based on Wireless Smart Utility Network (Wi-SUN) (registered trademark) or Bluetooth (registered trademark). Further, the apparatuses constructing the WSN 108 do not have to be only the information processing apparatus 101 and the sensors 103 to 106, and may include another apparatus, such as a relay apparatus. Further, the WSN 108 may include a LAN and/or a WAN.

Each of the sensors 103 to 106 transmits the packet of the sensor data including the detection result to the information processing apparatus 101 via the WSN 108. The information processing apparatus 101 plays a role as a gateway for the WSN 108 toward the LAN/WAN 107. Therefore, the information processing apparatus 101 transfers a data packet transmitted from inside the WSN 108 to the LAN/WAN 107 side. Further, in the present exemplary embodiment, the server apparatus 102 associates the captured image and the sensor data with each other. Therefore, the information processing apparatus 101 determines whether the packet received from the WSN 108 is the packet of the sensor data including the detection result to be associated with the captured image that is transmitted to the server apparatus 102 by the streaming. Then, if the received packet is determined to be the packet to be associated, and a destination of this packet is the information processing apparatus 101, the information processing apparatus 101 transfers the packet by overwriting the destination of this packet with the server apparatus 102. The information processing apparatus 101 may include a sensor, and acquire a detection result detected by its own sensor and transmit the acquired detection result to the server apparatus 102. In the present exemplary embodiment, the captured image and the sensor data to be received by the server apparatus 102 are delivered via the information processing apparatus 101, so that the information processing apparatus 101 can perform preprocessing for the association processing in the server apparatus 102.

In the present exemplary embodiment, the information processing apparatus 101 communicates with both the LAN/WAN 107 and the WSN 108 based on Internet Protocol version 6 (IPv6). Further, assume that the WSN 108 uses IPv6 over Low-power Wireless Personal Area Networks (6LoWPAN), which is the protocol for the wireless PAN communication based on IPv6. 6LoWPAN is an IPv6 communication protocol suitable for a network that handles a transmission/reception frame having a small maximum unit size, like the wireless PAN. Each of the sensors 103 to 106 transmits the packet based on the 6LoWPAN protocol. Then, the information processing apparatus 101 converts the packet in the 6LoWPAN format received from the WSN 108 into a normal IPv6 packet, and transfers the converted packet to the LAN/WAN 107 side. However, the protocol used in the communication in the information processing system 100 is not limited thereto, and, for example, Internet Protocol version 4 (IPv4) or the like may be used.

### <Communication Patterns>

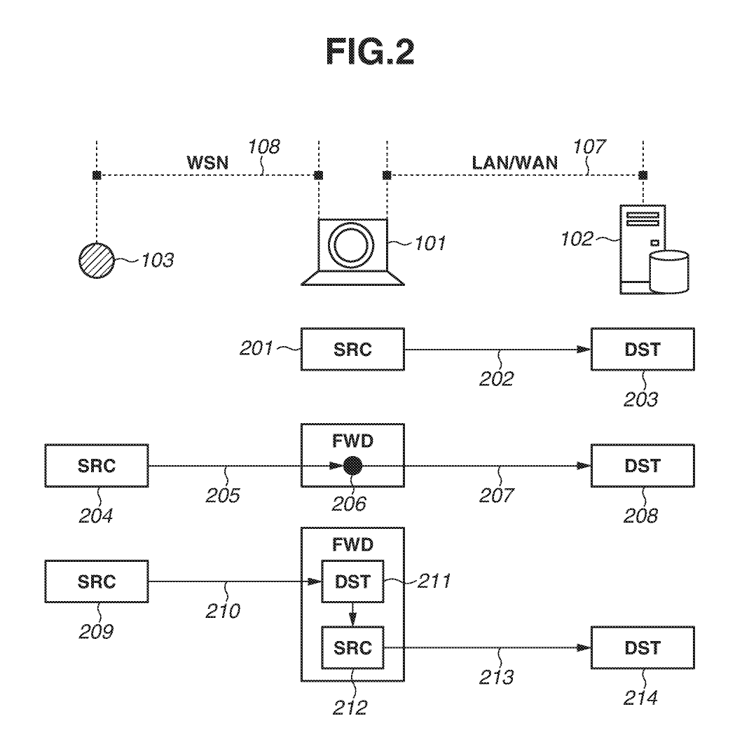

Next, communication patterns in the information processing system 100 will be described with reference to FIG. 2. FIG. 2 illustrates the sensor 103 as a representative of the sensors 103 to 106 that communicate with the information processing apparatus 101, but the illustrated sensor may be replaced with any of the other sensors (sensors 104 to 106) in the WSN 108. As described above, the information processing apparatus 101 communicates with the sensor 103 via the WSN 108, and communicates with the server apparatus 102 via the LAN/WAN 107. FIG. 2 illustrates three patterns in which the information processing apparatus 101 transmits or transfers the sensor data including the detection result.

First, a first pattern (201 to 203) is a communication pattern when the information processing apparatus 101 itself senses some event or value to generate the sensor data, and transmits the generated sensor data to the server apparatus 102. In this pattern, a packet with the information processing apparatus 101 set as a transmission source 201 of the sensor data and the server apparatus 102 set as a destination 203 is transmitted via communication 202 based on IPv6.

Then, a second pattern (204 to 208) is a communication pattern when the information processing apparatus 101 transfers the sensor data received from the sensor 103. In this pattern, a packet with the sensor 103 set as a transmission source 204 and the server apparatus 102 set as a final destination 208 is transmitted via communication 205. The communication 205 is the IPv6 communication based on 6LoWPAN that is carried out between the sensor 103 and the information processing apparatus 101. Upon receiving the packet from the WSN 108, the information processing apparatus 101 converts the format of the packet from the 6LoWPAN format into the normal IPv6 format, and performs transfer processing 206 for transferring the converted packet to the LAN/WAN 107 side. The packet is transmitted via communication 207 according to this transfer processing 206. The communication 207 is the normal IPv6 communication carried out between the information processing apparatus 101 and the server apparatus 102.

Then, a third pattern (209 to 214) is a communication pattern when the information processing apparatus 101 changes the destination of the sensor data received from the sensor 103 and transfers this sensor data to the server apparatus 102. In this pattern, a packet with the sensor 103 set as a transmission source 209 and the information processing apparatus 101 set as a destination 211 therein is transmitted via communication 210 based on 6LoWPAN. The information processing apparatus 101 receives the sensor data transmitted via the communication 210 based on 6LoWPAN, and changes the sensor data in such a manner that the information processing apparatus 101 itself is set as a transmission source 212 and the server apparatus 102 is set as a destination 214. Then, this sensor data is transmitted via communication 213 based on IPv6, by which the transfer of the sensor data is realized.

The information processing apparatus 101 can also transfer the sensor data transmitted from another sensor (sensors 104 to 106) to the server apparatus 102 according to the above-described second or third pattern. Regarding the communication 202, the communication 205, the communication 207, the communication 210, and the communication 213, any of them may be the communication based on IPv4.

### <Hardware Configuration of Information Processing Apparatus 101>

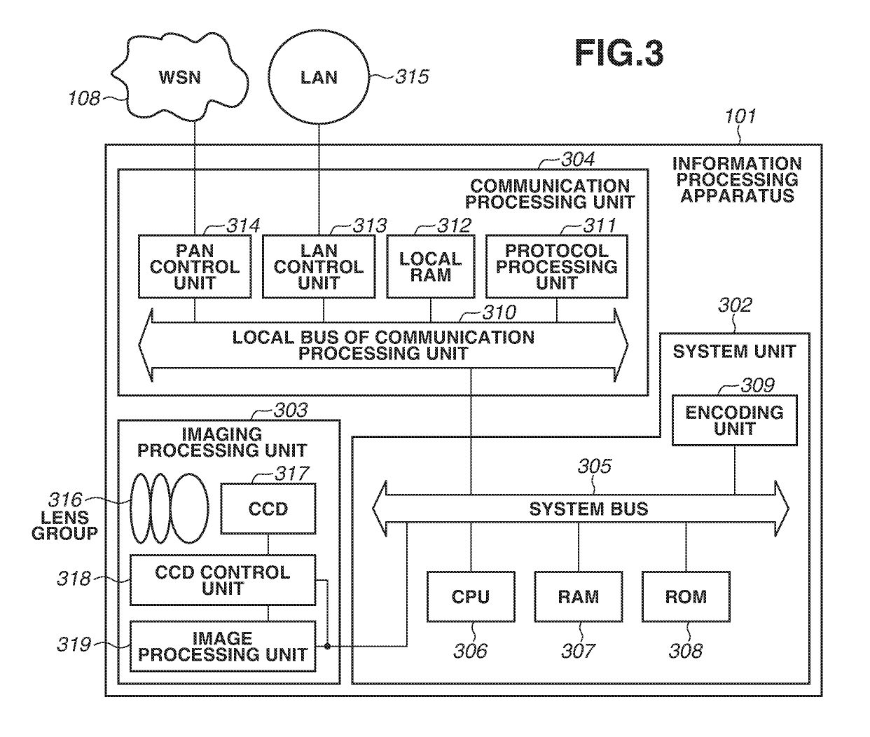

Next, a hardware configuration of the information processing apparatus 101 according to the present exemplary embodiment will be described with reference to FIG. 3. The information processing apparatus 101 mainly includes a system unit 302, an imaging processing unit 303, and a communication processing unit 304 as the hardware configuration thereof.

The system unit 302 includes a system bus 305, a central processing unit (CPU) 306, a random access memory (RAM) 307, a read only memory (ROM) 308, and an image encoding processing unit 309 (hereinbelow, referred to as an encoding unit 309). The system bus 305 connects the CPU 306, the RAM 307, the ROM 308, and the encoding unit 309 to one another, and transmits information among them. The CPU 306 controls the entire information processing apparatus 101 with use of a computer program and data stored in the RAM 307 or the ROM 308. The RAM 307 is a main storage unit of the information processing apparatus 101, and is used as a temporary storage area for execution of the program and an input to and output from the communication processing unit 304 and the imaging processing unit 303 by the CPU 306. The ROM 308 is a nonvolatile storage unit storing an operating system (OS) and a software program of an application that are executed by the CPU 306. The program stored in the ROM 308 is transferred to the RAM 307, and is read out and executed by the CPU 306. The encoding unit 309 encodes digital image signal data generated by the imaging processing unit 303 into moving image data compressed in a compression format, such as Joint Photographic Experts Group (JPEG) and H.264.

The imaging processing unit 303 includes a lens group 316, a charge coupled device (CCD) sensor 317 (hereinbelow, referred to as CCD 317), a CCD control unit 318, and an image processing unit 319. The lens group 316 includes a plurality of lenses for optically projecting an image of the object onto the CCD 317. The CCD 317, which includes a photoelectric conversion device, is a device for converting the image projected by the lens group 316 into an analog electric signal. The CCD control unit 318 includes a timing generator for supplying a transfer clock signal and a shutter signal to the CCD 317, and a circuit for performing a noise removal operation and gain adjustment processing on an output signal from the CCD 317. Further, the CCD control unit 318 also includes, for example, an analog-to-digital (A/D) conversion circuit for converting the analog signal into a digital signal. Further, the image processing unit 319 performs image processing such as a gamma conversion processing, a color space conversion processing, a white balance adjustment processing, and an exposure correction processing on the digital signal output from the CCD control unit 318. The digital signal subjected to the image processing is output to the RAM 307 as the digital image signal data that can be encoded by the encoding unit 309.

The communication processing unit 304 includes a local bus 310, a protocol processing unit 311, a local RAM 312, a LAN control unit 313, and a PAN control unit 314. The local bus 310 connects the protocol processing unit 311, the local RAM 312, the LAN control unit 313, and the PAN control unit 314 to one another, and transmits information among them. The local RAM 312 temporarily stores data input or output between the communication processing unit 304 and the system unit 302, and data to be processed inside the communication processing unit 304.

The LAN control unit 313 is a communication interface connected to a LAN 315 included in the LAN/WAN 107, and transmits and receives a transmission packet between the communication processing unit 304 and the LAN 315. Further, the LAN control unit 313 includes a hardware circuit functioning as a physical layer (PHY) and media access control (MAC) of a transmission medium (for controlling the transmission medium). For example, in a case where the LAN 315 to which the information processing apparatus 101 is connected is of Ethernet (registered trademark), the LAN control unit 313 corresponds to an Ethernet network interface card (NIC). Alternatively, in a case where the information processing apparatus 101 is configured to be connected to the wireless LAN, the LAN control unit 313 includes a controller and a radio frequency (RF) circuit that perform wireless LAN control, based on Institute of Electrical and Electronics Engineers (IEEE) 802.11a/b/g/n/ac or the like.

The PAN control unit 314 is a communication interface in compliance with a wireless PAN standard that is connected to the WSN 108, and transmits and receives a transmission packet between the communication processing unit 304 and the WSN 108. Further, the PAN control unit 314 performs connection control according to a wireless communication standard such as ZigBee and Wi-SUN. In the present exemplary embodiment, the information processing apparatus 101 is assumed to be connected to the WSN 108 configured as the mesh network, but the information processing apparatus 101 may communicate with each of the sensors 103 to 106 via a peer-to-peer connection. Especially in such a case, the PAN control unit 314 may be an interface supporting the Bluetooth standard.

The protocol processing unit 311 is a hardware circuit device dedicated to communication protocol processing or a microprocessor designed for the communication protocol processing, and performs protocol processing in an upper layer on the packet transmitted and received between the communication processing unit 304 and the LAN 315 or the WSN 108. For example, the protocol processing unit 311 performs processing such as control of a transmission flow, control of congestion, and control of a communication error in IPv4, IPv6, Internet Control Message Protocol (ICMP), ICMP for IPv6 (ICMPv6), User Datagram Protocol (UDP), Transmission Control Protocol (TCP), or the like. Further, in the communication to the WSN 108, the protocol processing unit 311 also performs processing regarding the IPv6 protocol for 6LoWPAN, and processing regarding a route control protocol for IPv6 Routing Protocol for Low-Power and Lossy Networks (RPL).

In the present exemplary embodiment, the information processing apparatus 101 is assumed to have the hardware configuration including the imaging processing unit 303 therein, but the imaging processing unit 303 may be provided as another apparatus outside the information processing apparatus 101. For example, the information processing apparatus 101 may be configured in such a manner that an imaging apparatus prepared as a separate apparatus is connected to the information processing apparatus 101 via an image signal cable or the like, and the LAN control unit 313 or the PAN control unit 314 acquires the captured image data from the imaging apparatus.

### <Transfer of Sensor Data>

In the above description, the configurations of the information processing system 100 and the information processing apparatus 101 according to the present exemplary embodiment have been described. Next, the function of transferring the sensor data by the information processing apparatus 101 will be described. This transfer function is realized by the CPU 306 and the protocol processing unit 311.

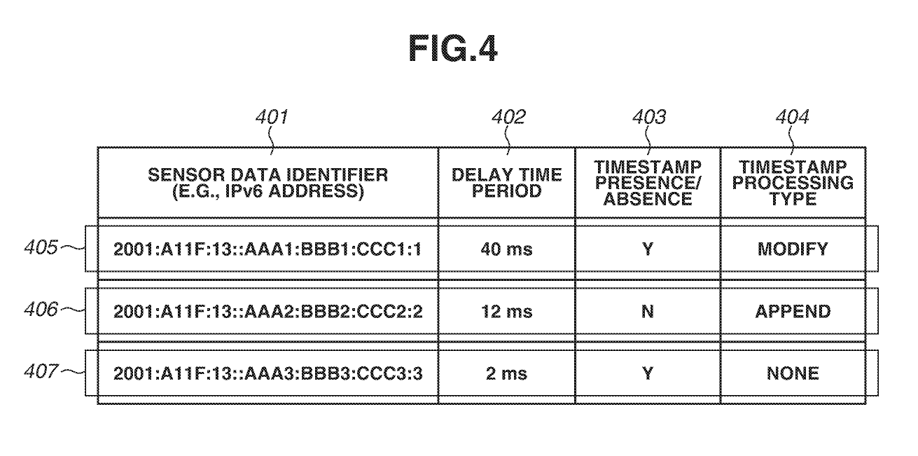

First, management information used by the information processing apparatus 101 in the processing for transferring the sensor data will be described with reference to FIG. 4. FIG. 4 illustrates a management table collectively storing the management information of the sensor data to be associated with the captured image. The management information is a set of parameters required for the transfer processing for transferring the packet of the sensor data received by the information processing apparatus 101 to the server apparatus 102. Each column illustrated in FIG. 4 is an example of a content of the management information, and indicates that the management information includes four kinds of parameters, i.e., a sensor data identifier 401, a communication delay time period 402, timestamp presence/absence 403, and a timestamp processing type 404. Then, each of entries 405 to 407 in individual rows is entry data corresponding to the sensor data to be transmitted from any of the sensors 103 to 106. The management information of each of the entries 405 to 407 is created by the information processing apparatus 101 based on the above-described setting specified by the server apparatus 102 or the user regarding which sensor data (detection result) is associated with the captured image. The information processing apparatus 101 creates no entry corresponding to the sensor data not to be associated with the captured image. The content of the management information is not limited to the content illustrated in FIG. 4.

The sensor data identifier 401 is identification information usable to distinguish the packet of the sensor data to be associated with the captured image and the packet of the sensor data not to be associated with the captured image from each other. The information processing apparatus 101 determines that a packet having the matching sensor data identifier 401 among received packets is the packet of the sensor data to be associated with the captured image. In the present exemplary embodiment, only an IPv6 address of the transmission source is used as the sensor data identifier 401. However, a combination of an IPv6 address of the destination of the packet, a type of the upper-layer protocol used in the communication of the sensor data, another parameter dependent on a format of the sensor data, and the like may be used as the sensor data identifier 401.

The communication delay time period 402 indicates a delay time period from the transmission of the packet from the sensor in the WSN 108 to the arrival at the information processing apparatus 101. This parameter is not a fixed value, and the delay time period changes depending on, for example, a condition of the WSN 108. Therefore, the information processing apparatus 101 measures the delay time period regarding the communication between the information processing apparatus 101 and each of the sensors 103 to 106 as appropriate, and updates the communication delay time period 402 in the management table.

The timestamp presence/absence 403 is a flag indicating whether a timestamp, which is the time information, is set to the sensor data packet to be received by the information processing apparatus 101. In FIG. 4, “Y” indicates that the timestamp is present, and “N” indicates that the timestamp is absent. The timestamp processing type 404 indicates what kind of processing is supposed to be performed on the timestamp when the information processing apparatus 101 transfers the packet. The processing employed if the timestamp is present in the packet of the sensor data when the packet is received is either MODIFY (modification) or NONE (nothing performed). For example, MODIFY is set as the timestamp processing type 404 of an entry corresponding to the sensor data containing a different type of timestamp from a timestamp of the captured image. On the other hand, NONE is set as the timestamp processing type 404 of an entry corresponding to the sensor data containing the same type of timestamp as the timestamp of the captured image. Further, the processing employed if the timestamp is absent when the packet is received is APPEND (addition). These pieces of information are predetermined based on the setting specified by the server apparatus 102 or the user when the information processing apparatus 101 creates the entries 405 to 407 as described above.

Now, suppose such an example that the time information indicating a time period elapsed from a predetermined moment is set to the captured image transmitted from the information processing apparatus 101, for facilitating the description of the timestamp processing. Possible examples of the above-described predetermined moment include a time point at which the imaging is started and a time point at which the transmission is started. In this case, if the information processing apparatus 101 transmits the sensor data to which information indicating a time point, such as Coordinated Universal Time (UTC), is set, a processing load on the server apparatus 102 may increase. More specifically, a likely consequence is that the server apparatus 102, which performs the processing while associating the received sensor data and the received captured image with each other, engages in processing for determining a correspondence relationship between two types of time information expressing time in different manners from each other (the time information indicating the elapsed time period and the time information indicating the time point) for the association. Especially, in a case where the server apparatus 102 performs the processing after receiving the captured images and the sensor data from the plurality of information processing apparatuses 101, for example, it is also possible that the above-described predetermined moment (the time point at which the imaging is started, the time point at which the transmission is started, or the like) is different for each captured image. In this case, a heavy processing load may occur regarding a plurality of association operations.

Therefore, if MODIFY is set as the timestamp processing type 404 of the received sensor data, the information processing apparatus 101 transfers the packet after modifying the time information thereof into the type according to the time information regarding the captured image. In the present exemplary embodiment, the modification will be described focusing on the example in which the information processing apparatus 101 modifies the time information of the sensor data into the same type as the time information of the captured image, but it is not limited thereto. For example, in a case where the time information of the sensor data is the information indicating the time point while the time information of the captured image is the information indicating the elapsed time period, the information processing apparatus 101 may modify the time information of the sensor data into the information indicating the elapsed time period. The time information generated from this modification may be different from the time information of the captured image in terms of a unit (for example, a clock rate).

On the other hand, if NONE is set as the timestamp processing type 404 of the received sensor data, the information processing apparatus 101 transfers the packet without performing any timestamp processing. Further, if APPEND is set as the timestamp processing type 404 of the received sensor data, the information processing apparatus 101 transfers the packet after adding the same type of time information as the time information regarding the captured image. However, for example, if the addition of the time information is impossible or unnecessary, the information processing apparatus 101 may transfer the packet without performing any timestamp processing on the packet to which no time information is set. Further, the information processing apparatus 101 may newly add the time information based on different information (e.g., a time point at which the packet is received) from the set time information to the packet to which the time information is set.

In this manner, the processing for associating the captured image and the sensor data with each other by the server apparatus 102 can be simplified by the information processing apparatus 101 performing the processing for matching the type of the time information regarding the sensor data and the type of the time information regarding the captured image. As a result, this configuration can reduce the processing load regarding the association based on the time information on the server apparatus 102. Further, a possibility that the processing load is concentrated on a single apparatus in the information processing system 100 can be reduced by each of the plurality of information processing apparatuses 101 in the information processing system 100 performing the processing for matching the types of the time information. Specific methods for the modification and the addition of the time information by the information processing apparatus 101 will be described below.

### <Operation Flow>

Next, an operation flow of the information processing apparatus 101 will be described. First, processing regarding the captured image by the information processing apparatus 101 will be described. The imaging processing unit 303 acquires the captured image by carrying out the imaging. Alternatively, the communication processing unit 304 may acquire the captured image by receiving the captured image from an external apparatus. The communication processing unit 304 transmits the captured image acquired by the imaging processing unit 303 and the time information of this captured image to the server apparatus 102. In the present exemplary embodiment, the communication processing unit 304 transmits the captured image and the time information to the server apparatus 102 by the streaming based on RTP. A header of an RTP packet includes a timestamp field, and the information processing apparatus 101 can add the time information to the captured image to then transmit them by writing a value into this field. However, the information processing apparatus 101 may transmit the captured image by a method other than RTP, such as Hypertext Transfer Protocol (HTTP). Further, the captured image and the time information regarding this captured image may be transmitted simultaneously as one piece of data, or may be transmitted separately.

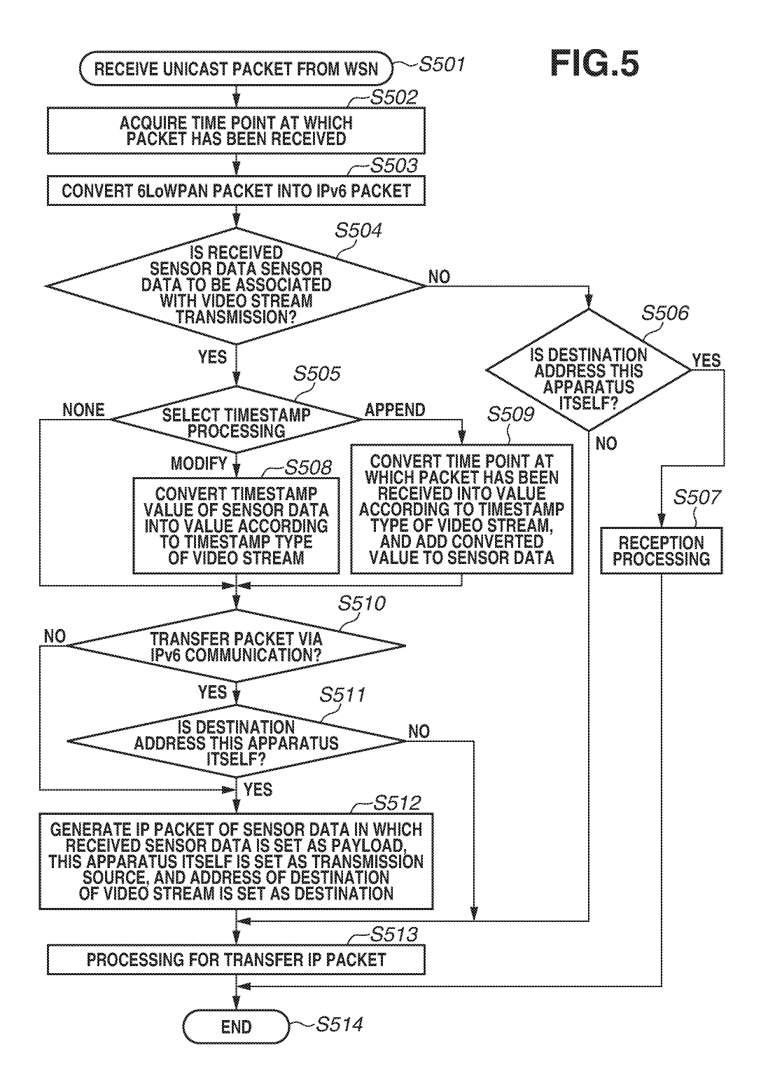

Next, an operation flow regarding the processing for transferring the sensor data by the information processing apparatus 101 will be described with reference to FIG. 5. The CPU 306 and the protocol processing unit 311 execute the program stored in the ROM 308, by which the processing illustrated in FIG. 5 is realized.

In step S501, the communication processing unit 304 receives the packet from the WSN 108, and the processing illustrated in FIG. 5 is started at this timing. The packet that the communication processing unit 304 receives from the WSN 108 in the present exemplary embodiment is a unicast packet based on 6LoWPAN that is transmitted from the external sensor, and the packet of the sensor data including the detection result detected by the sensor. The communication processing unit 304 acquires the detection result detected by the sensor by receiving this packet. However, in a case where the information processing apparatus 101 includes the sensor, the communication processing unit 304 may acquire the detection result of the sensor that the information processing apparatus 101 itself includes. Further, the communication processing unit 304 may receive a packet other than the sensor data.

In step S502, the communication processing unit 304 acquires and stores a time point at which the packet has been received in step S501, i.e., a timing when the detection result detected by the sensor has been acquired. In step S503, the communication processing unit 304 converts the format of the received 6LoWPAN packet into the format of the normal IPv6 packet that is not subjected to the compression based on 6LoWPAN. In the present exemplary embodiment, the information processing apparatus 101 first converts the received packet into the IPv6 format, but may treat the packet according to another format, such as IPv4. In step S504, the communication processing unit 304 determines whether the detection result acquired in step S501 is the detection result to be associated with the captured image that is acquired by the imaging processing unit 303. More specifically, the communication processing unit 304 searches for an entry having the sensor data identifier 401 matching the sensor data identifier of the received packet in the management table exemplified in FIG. 4. If an entry is found out as a result of the search (YES in step S504), the communication processing unit 304 determines that this received packet is the packet of the sensor data including the detection result to be associated with the captured image, and the processing proceeds to step S505. If not (NO in step S504), the processing proceeds to step S506.

In step S505, the processing branches according to the timestamp processing type 404 of the entry found out in the process in step S504. If the timestamp processing type 404 is “MODIFY” (MODIFY in step S505), the processing proceeds to step S508. If the timestamp processing type 404 is “APPEND” (APPEND in step S505), the processing proceeds to step S509. If the timestamp processing type 404 is “NONE” (NONE in step S505), the processing proceeds to step S510 without any timestamp processing performed.

If the processing proceeds to step S508 (MODIFY in step S505), the detection result acquired by the communication processing unit 304 in step S501 contains the timestamp as the time information. Then, the communication processing unit 304 converts the time information of this detection result into the type according to the time information of the captured image that is transmitted to the server apparatus 102. By this conversion, the type of time information according to the time information of the captured image is generated as the time information of the detection result. Details of the process in step S508 will be described below. On the other hand, if the processing proceeds to step S509 (APPEND in step S505), the communication processing unit 304 generates the time information of the detection result based on the time point at which the packet has been received, which has been acquired in step S502, i.e., the timing when the detection result detected by the sensor has been acquired. At this time, the communication processing unit 304 generates the type of time information according to the time information of the captured image that is transmitted, as the time information of the detection result. The generated time information is added to the packet of the sensor data as the timestamp. Details of the process in step S509 will also be described below.

In step S510, the communication processing unit 304 determines whether to transfer the sensor data via the IPv6 communication or transfer the sensor data by another method. If the transmission of the captured image is the IPv6 communication, the sensor data is also transferred via the IPv6 communication. If not, the sensor data is transferred by another method. In the present exemplary embodiment, the transfer of the sensor data will be described based on an example in which the IPv4 communication is employed as the method other than the IPv6. If the sensor data will be transferred via IPv4 (NO in step S510), the processing proceeds to step S12. If the sensor data will be transferred via IPv6 (YES in step S510), the processing proceeds to step S511. However, the method for determining the communication method is not limited thereto.

In step S511, the communication processing unit 304 checks whether the destination address of the packet received in step S501 is the address of this apparatus itself. If the destination address is the address of this apparatus itself, i.e., the address of the information processing apparatus 101 (YES in step S511), the processing proceeds to step S512. If not (NO in step S511), the destination address is the same as the destination address of the captured image that the communication processing unit 304 transmits, and, in other words, the destination is the server apparatus 102. In this case, the processing proceeds to step S513.

In step S512, the communication processing unit 304 generates a packet for delivering a payload in the packet of the sensor data received from the sensors 103 to 106 via the WSN 108 in step S501. If the destination address of the received packet has been the address of this apparatus itself in step S511 (YES in step S511), the communication processing unit 304 generates an IPv6 packet in which the information processing apparatus 101 is specified as the transmission source and the server apparatus 102 is specified as the destination. Further, if the communication processing unit 304 has determined to transfer the packet via the IPv4 communication in step S510 (NO in step S510), the communication processing unit 304 generates a packet by converting the IPv6 packet received in step S501 into the IPv4 format. Then, the processing proceeds from step S512 to step S513. Here, the processing proceeding from step S511 to step S513 while omitting step S512 corresponds to the second communication pattern illustrated in FIG. 2, and the processing proceeding from step S512 to step S513 corresponds to the third communication pattern illustrated in FIG. 2.

In step S513, the communication processing unit 304 performs the processing for transferring the IPv6 packet. The transfer processing in step S513 includes normally practiced routing processing for a transfer of an IP packet. If the processing proceeds from step S511 or S512 to step S513, the transfer destination is the server apparatus 102. Through this transfer processing, the communication processing unit 304 transmits the detection result acquired in step S501 and the time information of this detection result to the server apparatus 102. Then, if the communication processing unit 304 has generated the time information by converting the time information added to the detection result in step S508, the detection result and the converted time information are transmitted to the server apparatus 102. Alternatively, if the communication processing unit 304 has generated the time information regarding the detection result based on the time point at which the packet had been received in step S509, the detection result and this generated time information are transmitted to the server apparatus 102.

The above-described processing from step S505 to step S513 is the processing when the packet received in step S501 is determined in step S504 to be the packet of the detection result to be associated with the captured image. As described above, the communication processing unit 304 generates the type of time information according to the time information of the captured image as the time information of the data that is the detection result acquired from the sensor and is determined to be the detection result to be associated with the captured image, and transmits this time information to the server apparatus 102.

On the other hand, the advancement from step S504 to step S506 (NO in step S504) occurs if the packet received in step S501 is determined not to be the packet of the detection result to be associated with the captured image. The information processing apparatus 101 can omit the processing regarding the detection result unnecessary to be associated by performing the processing according to a result of the determination. However, in a case where, for example, the information processing apparatus 101 cannot determine whether each detection result is supposed to be associated, the processing corresponding to APPEND or the processing corresponding to NONE defined as the timestamp processing type 404 may be performed on all detection results acquired by the information processing apparatus 101.

In step S506, the communication processing unit 304 checks whether the destination address of the packet received in step S501 is the address of this apparatus itself. If the packet is addressed to this apparatus itself (YES in step S506), the processing proceeds to step S507. In step S507, the communication processing unit 304 performs reception processing. If the packet is not addressed to this apparatus itself (NO in step S506), the processing proceeds to step S513. In step S513, the communication processing unit 304 performs the processing for transferring the IPv6 packet. In the transfer processing when the processing proceeds from step S506 to step S513, whether to actually transmit the IPv6 packet received by the communication processing unit 304 to the LAN/WAN 107 is determined according to the routing processing performed in step S513. When the process in step S513 completes, the processing proceeds to step S514 to end the present processing flow.

### <Timestamp Processing>

Next, the details of the timestamp processing in steps S508 and S509 will be described. As described above, in step S508, the communication processing unit 304 converts the type of the timestamp of the detection result detected by the sensor into the type of the timestamp of the captured image. In the present exemplary embodiment, the timestamp processing will be described focusing on the example in which the timestamp contained in the sensor data including the detection result is the type of time information expressing the time point, while the timestamp set to the captured image is the type of time information expressing the time period elapsed from the predetermined moment. As a specific example, particularly in the following description, the captured image and the time information thereof are assumed to be transmitted by the streaming based on RTP, and the above-described predetermined moment is assumed to be a moment that the communication processing unit 304 starts transmitting the captured image by the streaming.

The RTP packet in the communication based on RTP includes a 32-bit timestamp field in the header thereof. This timestamp of RTP does not indicate a time point but indicates a time period elapsed from a start of transmission of media data delivered in the payload in the RTP packet. Further, the timestamp in RTP is a value obtained by converting the elapsed time period into a clock rate defined for each media type in the payload thereof. The clock rate is a numerical value indicating a rate for one second. For example, in a case where video data based on H.264, Motion JPEG, or the like is transmitted by RTP, the clock rate is 90000, whereby the timestamp is 450000 for the RTP packet that delivers data after five seconds as the time period elapsed from the start of the transmission.

In step S508, the communication processing unit 304 converts the value of the timestamp of the sensor data into the type of the timestamp of the captured image with use of the following calculation equation.

Tt=CLKR÷1000×(Tsms−Tvms) [EQUATION 1]

In this equation, Tt represents the value of the timestamp after the conversion, and CLKR represents the clock rate determined from the protocol for the streaming and the media type of the captured image. Tsms represents a value obtained by rounding the time point that is the timestamp of the sensor data to millisecond precision, and Tvms represents a value obtained by rounding the time point at the moment that the streaming of the captured image is started to millisecond precision. The communication processing unit 304 sets the value Tt acquired as a result of this calculation to the timestamp of the packet of the sensor data. The server apparatus 102 can recognize the content of the time information added by the sensor to the detection result and also the processing for associating the captured image and the sensor data with each other can be simplified by the information processing apparatus 101 transmitting the time information after this conversion to the server apparatus 102.

On the other hand, in step S509, since the timestamp is not added to the sensor data, the communication processing unit 304 generates the timestamp with use of the following calculation equation.

Tg=CLKR÷1000×(Trms−Dms−Tvms) [EQUATION 2]

In this equation 2, Tg represents the value of the generated timestamp, and Trms represents a value obtained by rounding the time point at which the packet has been received, which has been acquired in step S502, to millisecond precision. Further, Dms represents the communication delay time period 402 written in the entry found out by the search in step S504. The communication processing unit 304 adds the value Tg acquired as a result of this calculation to the packet of the sensor data. The server apparatus 102 can associate the detection result detected by the sensor that does not add the timestamp to the detection result with the captured image based on the time information through the simple processing, by the information processing apparatus 101 transmitting the time information generated in this manner to the server apparatus 102.

In the above description, the processing for converting or adding the timestamp value of the sensor data has been described referring to the example in which the communication processing unit 304 transmits the captured image by the streaming based on RTP. However, not only when RTP is used but also when another protocol is used, the communication processing unit 304 can achieve a similar effect by converting the time information according to a type of time information thereof. Further, for example, the timestamp added to the detection result and the timestamp added to the captured image may be types of time information expressing time periods elapsed from different moments, and the information processing apparatus 101 may perform control so that these types match each other. In a case where it becomes necessary to correct a field value in a header of the upper-layer protocol, such as a check sum in a UDP header, the communication processing unit 304 also calculates this correction in addition to the conversion of the timestamp.

The information processing apparatus 101 may select any time information from pieces of time information of a plurality of transmitted captured images, and generate this selected time information as the time information of the detection result detected by the sensor. Hereinbelow, the processing in this case will be described.

If acquiring the detection result including the time information, the communication processing unit 304 selects any time information from the pieces of time information of the transmitted plurality of captured images, based on the time information contained in the acquired detection result. Then, the communication processing unit 304 generates this selected time information as the time information of the detection result to be transmitted in step S513. More specifically, in step S508, the communication processing unit 304 calculates the above-described timestamp value Tt. Further, the communication processing unit 304 selects a timestamp having a smallest time difference from Tt among timestamps corresponding to individual frames in the captured image that is the moving image transmitted based on RTP, and changes the timestamp added to the detection result to this selected value.

For example, suppose that the captured image is H.264 video data, and a frame rate thereof is 30 fps. The clock rate of the video data is 90000 as described above, whereby the timestamp value corresponding to each of the frames is set to, for example, a multiple of 3000. Therefore, if the calculated value of Tt is 1500 or larger and smaller than 4500, the communication processing unit 304 changes the value of the timestamp added to the detection result to 3000. Similarly, if the value of Tt is 4500 or larger and smaller than 7500, the communication processing unit 304 changes the value of the timestamp added to the detection result to 6000.

On the other hand, if acquiring the detection result to which the time information is not added by the sensor, the communication processing unit 304 selects any time information from the pieces of time information of the plurality of transmitted captured images, based on the timing when the detection result has been acquired. Then, the communication processing unit 304 generates this selected time information as the time information of the detection result to be transmitted in step S513. More specifically, in step S509, the communication processing unit 304 calculates the above-described timestamp value Tg. Further, the communication processing unit 304 selects a timestamp having a smallest time difference from Tg among the timestamps corresponding to the individual frames in the captured image, and generates a timestamp having this selected value and adds the generated timestamp to the detection result.

In the above-described manner, the information processing apparatus 101 performs control so that the time information regarding the detection result matches any of the pieces of time information regarding the captured image. As a result, the server apparatus 102, which associates the detection result and the captured image between which a difference between the detection timing and the imaging timing is smallest with each other, can achieve the intended association just by associating the detection result and the captured image having the same time information, and does not have to determine a magnitude relationship among the differences of the timings. This configuration allows the server apparatus 102 to more easily determine the relationship between the received captured image and the received detection result, and to further reduce the processing load regarding the association.

As described above, the information processing apparatus 101 according to the present exemplary embodiment acquires a first type of data (e.g., the detection result detected by the sensor). Then, the information processing apparatus 101 generates a type of time information according to time information of a second type of data (e.g., the captured image) different from the first type of data as time information of the acquired first type of data. Further, the information processing apparatus 101 transmits the acquired first type of data and the generated time information of the first type of data to the server apparatus 102, which receives the first type of data and the second type of data from a plurality of apparatuses and then performs processing while associating the first type of data and the second type of data with each other. This configuration can reduce the processing load regarding the association based on the time information in the apparatus that performs the processing while associating, with each other, the detection result detected by the sensor and the acquired captured image that are received from the plurality of apparatuses.

In the present exemplary embodiment, the timestamp processing has been described focusing on the example in which the information processing apparatus 101 generates the time information regarding the detection result according to the time information regarding the captured image as the control performed so as to match the type of the time information regarding the captured image and the type of the time information regarding the detection result. However, the timestamp processing is not limited thereto, and the information processing apparatus 101 may generate the time information regarding the captured image according to the time information regarding the detection result by a similar method. Further, the data targeted for the association by the server apparatus 102 is not limited to the detection result detected by the sensor and the captured image. For example, the server apparatus 102 may perform the processing while associating the detection result detected by the sensor and recorded audio data or the like with each other. In other words, the server apparatus 102 performs the processing while associating the first type of data (e.g., the sensor data) and the second type of data (contents, such as the captured image and the audio data) with each other. Then, the information processing apparatus 101 can achieve a similar effect by performing the control so as to match the type of the time information of the first type of data and the type of the time information of the second type of data, which the server apparatus 102 receives.

Further, in the present exemplary embodiment, the information processing apparatus 101 has been described based on the example in which the information processing apparatus 101 transmits both the captured image and the detection result detected by the sensor to the server apparatus 102, but it is not limited thereto and may be configured to transmit either one of the captured image and the detection result. For example, the information processing apparatus 101 transmits the detection result detected by the sensor to the server apparatus 102, and a different transmission apparatus from the information processing apparatus 101 transmits the captured image to the server apparatus 102. In this case, the information processing apparatus 101 acquires specific information specifying the type of the time information to be added to the captured image that the server apparatus 102 receives from the above-described transmission apparatus. This specific information may be, for example, transmitted from the server apparatus 102 to the information processing apparatus 101, or may be input by the user to the information processing apparatus 101. Then, the information processing apparatus 101 performs control so as to match the type of the time information regarding the detection result to be transmitted by the information processing apparatus 101 itself with the type of the time information added or to be added to the captured image that the server apparatus 102 receives based on the acquired specific information. Such a configuration can also reduce the processing load regarding the association by the server apparatus 102. Similarly, the information processing apparatus 101 may transmit the captured image to the server apparatus 102, and perform control so as to match the type of the time information regarding the captured image to be transmitted with the type of the time information to be added to the detection result that the server apparatus 102 receives.

Further, in the present exemplary embodiment, only the management information of the sensor data to be associated with the captured image is written in the management table exemplified in FIG. 4, and the information processing apparatus 101 determines whether the received packet is the target for the association based on whether there is the corresponding entry. However, the management table is not limited thereto, and the management information may be written in the management table with respect to all of the pieces of data including even the data not to be associated. In such a case, NONE is set as the timestamp processing type 404 of the data not to be associated. Then, the information processing apparatus 101 may process all of the received packets according to the management information written in the management table without determining whether the received packet is the target for the association.

According to the above-described exemplary embodiment, it is possible to reduce the processing load regarding the association based on the time information on the apparatus that performs the processing while associating the plurality of types of data received from the plurality of apparatuses with each other.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-072596, filed Mar. 31, 2016, which is hereby incorporated by reference herein in its entirety.

What is claimed is:

1. An information processing apparatus comprising:
an acquisition unit configured to acquire a first type of data;
a generation unit configured to generate a type of time information according to time information of a second type of data among a plurality of types of time information as time information of the first type of data; and
a transmission unit configured to transmit the first type of data and the time information of the first type of data to an external apparatus, the external apparatus being configured to receive the first type of data and the second type of data from plurality of apparatuses and then perform processing while associating the first type of data and second type of data with each other.

2. The information processing apparatus according to claim 1, further comprising:
a second acquisition unit configured to acquire the second type of data; and
a second transmission unit configured to transmit the second type of data and the time information of the second type of data to the external apparatus,
wherein the generation unit generates the type of time information according to the time information of the second type of data among the plurality of types of time information as the time information of the first type of data.

3. The information processing apparatus according to claim 2, wherein the generation unit selects any time information from pieces of time information of a plurality of pieces of the second type of data, and generates the selected time information as the time information of the first type of data.

4. The information processing apparatus according to claim 3,
wherein the acquisition unit acquires the first type of data having the time information, and
wherein the generation unit selects any time information from the pieces of time information of the plurality of pieces of the second data, based on the time information contained in the first type of data, and generates the selected time information as the time information of the first type of data.

5. The information processing apparatus according to claim 3, wherein the generation unit selects any time information from the pieces of time information of the plurality of pieces of the second type of data, based on a timing at which the acquisition unit acquires the first type of data, and generates the selected time information as the time information of the first type of data.

6. The information processing apparatus according to claim 2,
wherein the acquisition unit acquires a detection result detected by an external sensor as the first type of data, and
wherein the second acquisition unit acquires a captured image as the second type of data by carrying out imaging.

7. The information processing apparatus according to claim 1,
wherein the acquisition unit acquires the first type of data having the time information, and
wherein the generation unit generates the time information of the first type of data by converting the time information contained in the first type of data into a type of the time information according to the time information of the second type of data.

8. The information processing apparatus according to claim 1, wherein the generation unit generates the time information of the first type of data by converting the time information contained in the first type of data from a type of time information expressing a time point into a type of time information expressing a time period elapsed from a predetermined moment.

9. The information processing apparatus according to claim 1, wherein the generation unit generates the type of time information according to the time information of the second type of data based on a timing at which the acquisition unit acquires the first type of data as the time information of the first type of data.

10. The information processing apparatus according to claim 1, further comprising a determination unit configured to determine whether the first type of data is data to be associated with the second type of data that is received by the external apparatus,
wherein the generation unit generates the type of time information according to the time information of the second type of data as time information of data that is the first type of data and is determined to be the data to be associated.

11. The information processing apparatus according to claim 1, wherein the generation unit generates a same type of time information as the time information of the second type of data among the plurality of types of time information as the time information of the first type of data.

12. The information processing apparatus according to claim 1,
wherein the first type of data is a detection result detected by a sensor;
wherein the second type of data is a captured image, and
wherein the processing that the external apparatus performs while associating the first type of data and the second type of data with each other includes processing for performing control so as to display the second type of data having time information matching or close to the time information of the first type of data received by the external apparatus.

13. The information processing apparatus according to claim 1, wherein the first type of data includes at least any one of information indicating that a predetermined event is detected by a sensor and information of a numerical value acquired from measurement carried out by a sensor.

14. The information processing apparatus according to claim 2, wherein the second transmission unit transmits the second type of data and the time information of the acquired second type of data to the external apparatus by streaming based on Real-time Transport Protocol (RTP).

15. An information processing method comprising:
acquiring a first type of data, as acquisition;
generating a type of time information according to time information of a second type of data among a plurality of types of time information as time information of the first type of data, as generation; and
transmitting the first type of data and the time information of the first type of data that is generated in the generation to an external apparatus, the external apparatus being configured to receive the first type of data and the second type of data from plurality of apparatuses and then perform processing while associating the first type of data and second type of data with each other, as transmission.

16. The information processing method according to claim 15, further comprising:
acquiring the second type of data, as second acquisition; and
transmitting the second type of data and the time information of second type of data to the external apparatus, as second transmission,
wherein, in the generation, the type of time information according to the time information of the second type of data that is transmitted in the second transmission, among the plurality of types of time information, is generated as the time information of the first type of data.

17. The information processing method according to claim 15,
wherein, in the acquisition, the first type of data having the time information is acquired, and
wherein, in the generation, the time information of the first type of data is generated by converting the time information contained in the first type of data into the type of the time information according to the time information of the second type of data.

18. A storage medium storing a computer executable program for performing an information processing method, the method comprising:
acquiring a first type of data, as acquisition;
generating a type of time information according to time information of a second type of data among a plurality of types of time information as time information of the first type of data, as generation; and
transmitting the first type of data and the time information of the first type of data that is generated in the generation to an external apparatus, the external apparatus being configured to receive the first type of data and the second type of data from plurality of apparatuses and then perform processing while associating the first type of data and second type of data with each other, as transmission.

19. The storage medium according to claim 18, further comprising:
acquiring the second type of data, as second acquisition; and
transmitting the second type of data and the time information of second type of data to the external apparatus, as second transmission,
wherein, in the generation, the type of time information according to the time information of the second type of data that is transmitted in the second transmission, among the plurality of types of time information, is generated as the time information of the first type of data.

20. The storage medium according to claim 18,
wherein, in the acquisition, the first type of data having the time information is acquired, and
wherein, in the generation, the time information of the first type of data is generated by converting the time information contained in the first type of data into the type of the time information according to the time information of the second type of data.
